(19) United States
(12) Patent Application Publication
(10) Pub. No.: US 2026/0128407 A1
(43) Pub. Date: May 7, 2026

(54) COOLING MODULE AND BATTERY PACK INCLUDING THE SAME

(71) Applicants: Hyundai Motor Company, Seoul (KR); Kia Corporation, Seoul (KR)

(72) Inventors: Kyung Mo KIM, Hwaseong-Si (KR); Jong Gyu PARK, Hwaseong-Si (KR); Si Won KIM, Hwaseong-Si (KR); Gun Woo KO, Hwaseong-Si (KR)

(73) Assignees: Hyundai Motor Company, Seoul (KR); Kia Corporation, Seoul (KR)

(21) Appl. No.: 19/271,567

(22) Filed: Jul. 16, 2025

(30) Foreign Application Priority Data
Nov. 5, 2024 (KR) 10-2024-0155657

(51) Int. Cl. H01M 10/6556; H01M 10/613; H01M 10/6568; H01M 50/204; H01M 50/244; H01M 50/289

(52) U.S. Cl. CPC H01M 10/6556; H01M 10/613; H01M 10/6568; H01M 50/244; H01M 50/289; H01M 50/204

(57) ABSTRACT

A cooling module includes a supply manifold block connected to an inlet pipe into which cooling water is introduced and that distributes the cooling water, a collection manifold block connected to a discharge pipe from which the cooling water is discharged, collecting and delivering the cooling water to the discharge pipe, a plurality of first channels including a portion which is connected to the supply manifold block, a return manifold block which is connected to the plurality of first channels and that changes a flow direction of the cooling water delivered from the plurality of first channels, a plurality of second channels that connect the return manifold block and the collection manifold block, and a bypass channel that bypasses the first channels, receives the cooling water from the supply manifold block, and delivers the cooling water to the return manifold block through a passage shorter than the first channels.

### CROSS-REFERENCE TO RELATED APPLICATION

The present application claims the benefit of priority to Korean Patent Application No. 10-2024-0155657, filed in the Korean Intellectual Property Office on Nov. 5, 2024, the entire contents of which are incorporated herein by reference.

### TECHNICAL FIELD

The present disclosure relates to a cooling module and a battery pack including the same.

### BACKGROUND

In recent years, research and development on electric vehicles, which are environment-friendly vehicles, has been emphasized as crisis awareness of environments and oil resource depletion has increased.

An electric vehicle, which is a vehicle powered by electricity, may include a battery pack. The battery pack may include a base plate for supporting a battery module or a battery cell stack that includes a plurality of battery cells formed therein.

It is necessary to maintain a predetermined temperature for the performance of the battery cells, and a structure for this end may be classified into an air cooling type that adjusts the temperature of the battery cells by circulating air, a direct cooling type that adjusts the temperature of the battery cells using a refrigerant, and a water cooling type that adjusts the temperature of the battery module using water.

In the water cooling type, there is a method of cooling the battery cells using cooling water. With regard to a structure for forming a cooling water channel that causes the cooling water to flow, a method of forming the cooling water channel by press forming has a problem of relatively weak rigidity and a problem caused by brazing, and therefore there is a growing need to address the problems.

In addition, in the water cooling type, there is a problem that the cooling performance of the battery cells deteriorates due to a temperature difference depending on positions in the width direction of the battery cells, and therefore there is a growing need to address the problem.

### SUMMARY

The present disclosure has been made to solve the above-mentioned problems occurring in the related art while advantages achieved by the related art are maintained intact.

An aspect of the present disclosure provides a cooling module for preventing deterioration in cooling performance of battery cells by reducing a temperature difference depending on positions in the width direction of the battery cells and a battery pack including the cooling module.

Another aspect of the present disclosure provides a cooling module configured for being manufactured using an extrusion mold rather than a press forming mold and a battery pack including the cooling module.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a cooling module includes a supply manifold block that is connected to an inlet pipe into which cooling water is introduced and that distributes the cooling water, a collection manifold block that is connected to a discharge pipe from which the cooling water is discharged and that collects and delivers the cooling water to the discharge pipe, a plurality of first channels including a portion that is connected to the supply manifold block and that extends in one direction, the plurality of first channels being spaced apart from each other, a return manifold block that is connected to the plurality of first channels and that changes a flow direction of the cooling water delivered from the plurality of first channels, a plurality of second channels that connect the return manifold block and the collection manifold block, and a bypass channel that bypasses the plurality of first channels, receives the cooling water from the supply manifold block, and delivers the cooling water to the return manifold block through a passage shorter than the plurality of first channels.

The bypass channel may be disposed between the plurality of first channels in a direction crossing the one direction and may extend in the one direction from the supply manifold block to the return manifold block.

The bypass channel may be spaced apart from the plurality of first channels in a direction crossing the one direction.

Each of the first channels may include a first area that is connected to the supply manifold block and that extends in the one direction and a second area which is located downstream of the first area with respect to the flow direction of the cooling water and that extends in an opposite direction opposite to the one direction.

The first channel may further include a third area which is located downstream of the second area with respect to the flow direction of the cooling water and connected to the return manifold block and that extends in the one direction.

The first channel may further include a first connection area that connects the first area and the second area and extends in a direction crossing the one direction and a second connection area that connects the second area and the third area and extends in the direction crossing the one direction.

The plurality of first channels may include a first-first channel and a first-second channel disposed outward of the first-first channel in a direction crossing the one direction and spaced apart from the first-first channel, and a flow rate of the cooling water distributed from the supply manifold block to the first-second channel may be greater than a flow rate of the cooling water distributed from the supply manifold block to the first-first channel.

The cooling module may further include at least one first distribution connection pipe that connects the supply manifold block and the first-first channel and at least one second distribution connection pipe that connects the supply manifold block and the first-second channel, and a number of the at least one second distribution connection pipe may be greater than a number of the at least one first distribution connection pipe.

The cooling module may further include a first distribution connection pipe that connects the supply manifold block and the first-first channel and a second distribution connection pipe that connects the supply manifold block and the first-second channel, and a cross-sectional area of the second distribution connection pipe may be a larger than a cross-sectional area of the first distribution connection pipe.

Each of the first-first channel and the first-second channel may include a first area that is connected to the supply manifold block and that extends in the one direction. The cooling module may further include a first distribution connection pipe that connects the supply manifold block and the first-first channel and a second distribution connection pipe that connects the supply manifold block and the first-second channel. The first distribution connection pipe and the second distribution connection pipe may be connected to positions offset from a center portion of the first area of the first-first channel and a center portion of the first area of the first-second channel in the direction crossing the one direction.

The first distribution connection pipe may be connected, at a position inwardly of the center portion of the first area of the first-first channel in the direction crossing the one direction, to the first-first channel, and the second distribution connection pipe may be connected, at a position outward of the center portion of the first area of the first-second channel in the direction crossing the one direction, to the first-second channel.

The supply manifold block may be connected, at a position inwardly of the plurality of first channels in the direction crossing the one direction, to the bypass channel.

The return manifold block may be connected, at a position inwardly of the plurality of first channels in a direction crossing the one direction, to the bypass channel.

Each of the second channels may be disposed outward of the plurality of first channels in a direction crossing the one direction.

The return manifold block may be connected, at a position outward of the plurality of first channels in a direction crossing the one direction, to the plurality of second channels.

The plurality of first channels, the plurality of second channels, and the bypass channel may be formed of an extruded material.

According to another aspect of the present disclosure, a battery pack includes a battery cell stack including battery cells that are stacked in one direction and that extend in a direction crossing the one direction and a base plate that supports the battery cell stack and includes a cooling module therein. The cooling module includes a supply manifold block that is connected to an inlet pipe into which cooling water is introduced and that distributes the cooling water, a collection manifold block that is connected to a discharge pipe from which the cooling water is discharged and that collects and delivers the cooling water to the discharge pipe, a plurality of first channels including a portion that is connected to the supply manifold block and that extends in the one direction, the plurality of first channels being spaced apart from each other, a return manifold block that is connected to the plurality of first channels and that changes a flow direction of the cooling water delivered from the plurality of first channels, a plurality of second channels that connect the return manifold block and the collection manifold block, and a bypass channel that bypasses the plurality of first channels, receives the cooling water from the supply manifold block, and delivers the cooling water to the return manifold block through a passage shorter than the plurality of first channels.

The bypass channel may be disposed between the plurality of first channels in a direction crossing the one direction and extends in the one direction from the supply manifold block to the return manifold block.

The bypass channel may be spaced apart from the plurality of first channels in a direction crossing the one direction.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view of a pack housing and battery cell stacks according to an exemplary embodiment of the present disclosure;

FIG. 2 is an exploded perspective view of a battery pack according to an exemplary embodiment of the present disclosure;

FIG. 3 is a bottom perspective view of the pack housing according to an exemplary embodiment of the present disclosure;

FIG. 4 is a plan view of a cooling module according to an exemplary embodiment of the present disclosure;

FIG. 5 is a view exemplarily illustrating a flow direction of cooling water flowing through the cooling module according to an exemplary embodiment of the present disclosure;

FIG. 6 is an enlarged view of portion A illustrated in FIG. 4; and

FIG. 7 is a view exemplarily illustrating the temperature of cooling water flowing through the cooling module according to an exemplary embodiment of the present disclosure.

### DETAILED DESCRIPTION

Hereinafter, various exemplary embodiments of the present disclosure will be described in detail with reference to the exemplary drawings. In adding the reference numerals to the components of each drawing, it should be noted that the identical or equivalent component is predetermined by the identical numeral even when they are displayed on other drawings. Furthermore, in describing the exemplary embodiment of the present disclosure, a detailed description of well-known features or functions will be ruled out in order not to unnecessarily obscure the gist of the present disclosure.

In describing the components of the exemplary embodiment according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, include the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

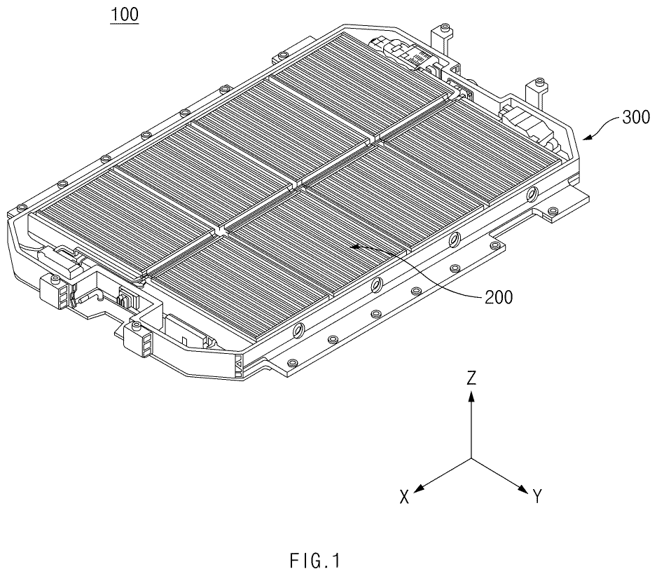

Hereinafter, embodiments of the present disclosure will be described in detail with reference to FIGS. 1 to 7. A first direction may be an X direction or a direction opposite to the X direction, a second direction may be a Y direction or a direction opposite to the Y direction, and a third direction may be a Z direction or a direction opposite to the Z direction. The first direction may be the overall-length direction of an electric vehicle, and the second direction may be the width direction of the electric vehicle.

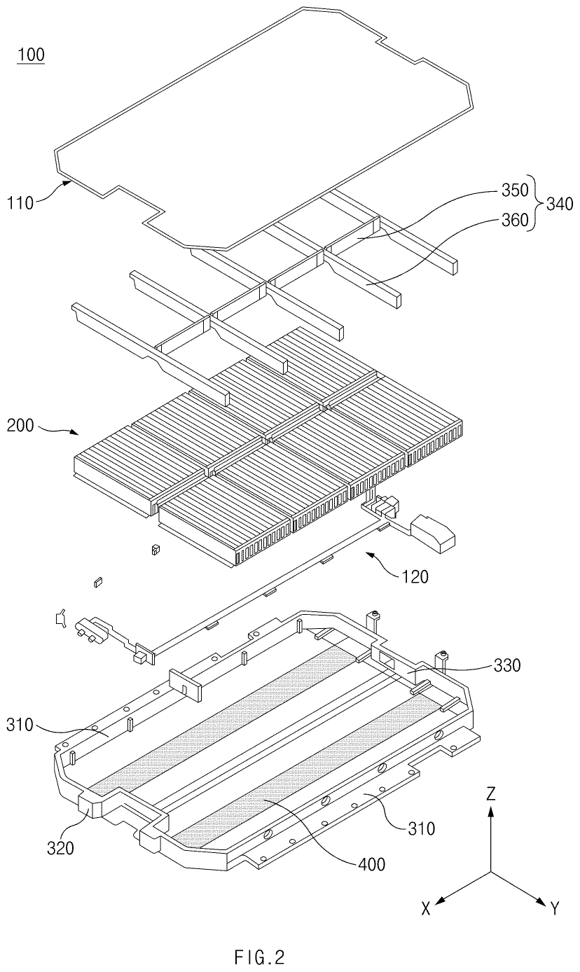

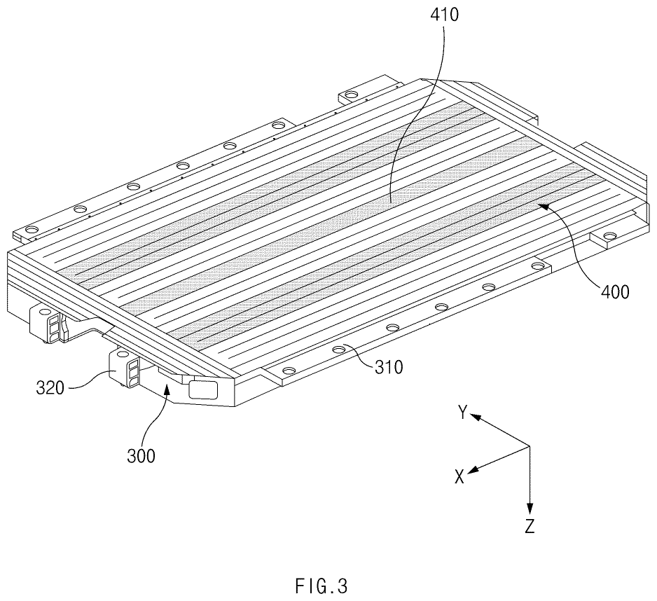

FIG. 1 is a perspective view of a pack housing and battery cell stacks according to an exemplary embodiment of the present disclosure. FIG. 2 is an exploded perspective view of a battery pack according to an exemplary embodiment of the present disclosure. FIG. 3 is a bottom perspective view of the pack housing according to an exemplary embodiment of the present disclosure.

Referring to FIGS. 1 to 3, the battery pack 100 may be mounted in the electric vehicle and may provide power for the electric vehicle. The battery pack 100 may include the battery cell stacks 200 and the pack housing 300 that supports the battery cell stacks 200.

The battery pack 100 may include a pack cover 110 that covers areas of the battery cell stacks 200 that face toward one side in the third direction (face in the Z direction) and an electronic module 120 connected to the battery cell stacks 200.

Each of the battery cell stacks 200 may include a plurality of battery cells that are stacked in the first direction (the X direction or the direction opposite to the X direction) and that extend in the second direction (the Y direction or the direction opposite to the Y direction). However, unlike those illustrated in FIG. 1, three battery cell stacks 200 may be mounted in the second direction (the Y direction or the direction opposite to the Y direction).

The pack housing 300 may include side members 310 disposed on opposite sides of the battery cell stacks 200 in the second direction, a front cover 320 that covers areas of the battery cell stacks 200 that face toward one side in the first direction (face in the X direction), and a rear cover 330 that covers areas of the battery cell stacks 200 that face toward an opposite side in the first direction (face in the direction opposite to the X direction).

The pack housing 300 may include cross members 340 that are provided between the battery cell stacks 200 and that support the battery cell stacks 200. The cross members 340 may include first cross members 350 extending in the first direction and second cross members 360 extending in the second direction.

The pack housing 300 may include a base plate 400 that supports the battery cell stacks 200. The base plate 400 may include a cooling module 410 therein. The cooling module 410 may include channels through which cooling water flows.

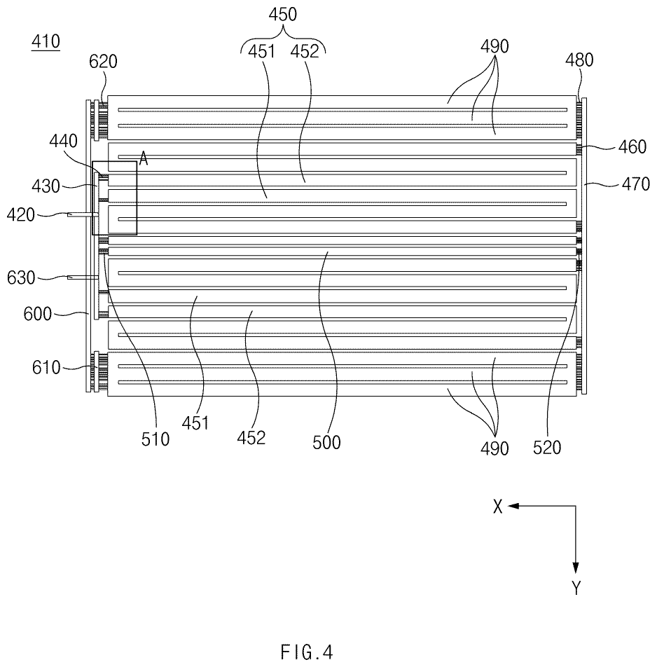

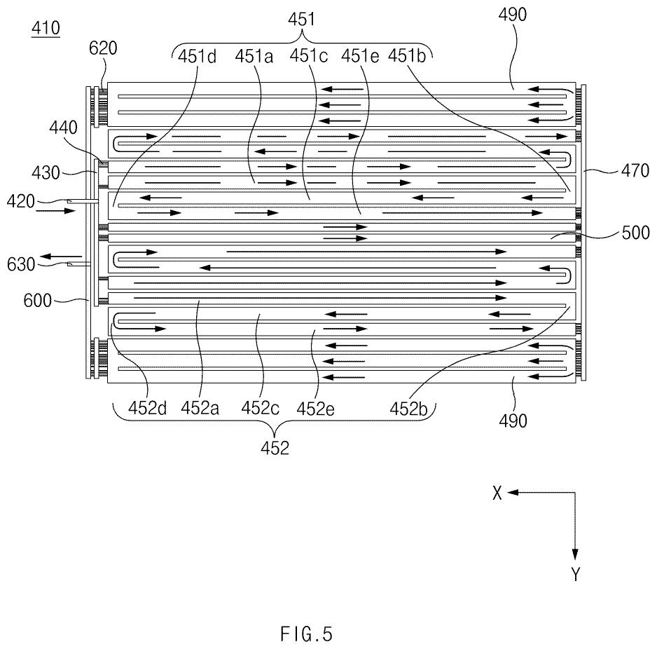

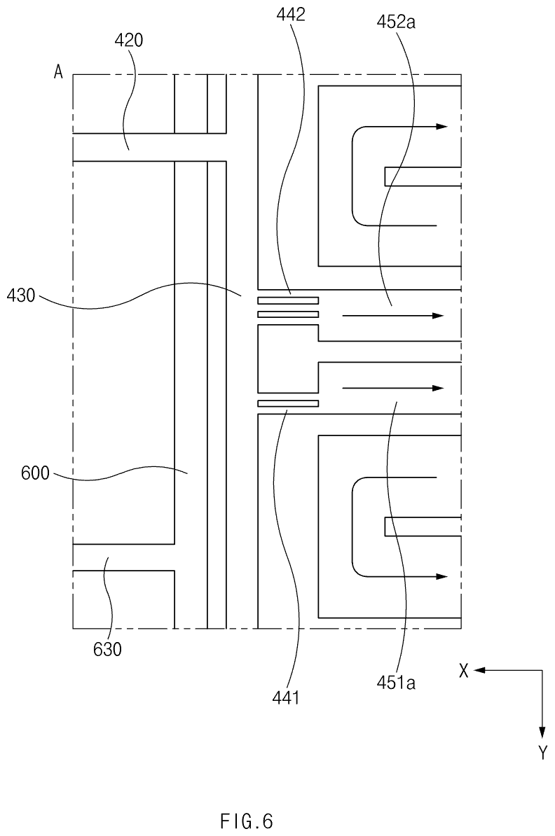

FIG. 4 is a plan view of the cooling module according to an exemplary embodiment of the present disclosure. FIG. 5 is a view exemplarily illustrating a flow direction of cooling water flowing through the cooling module according to an exemplary embodiment of the present disclosure. FIG. 6 is an enlarged view of portion A illustrated in FIG. 4.

Referring to FIGS. 4 to 6, the cooling module 410 may include an inlet pipe 420, a supply manifold block 430, a plurality of first channels 450, a return manifold block 470, a plurality of second channels 490, a bypass channel 500, a collection manifold block 600, and a discharge pipe 630.

Furthermore, the cooling module 410 may include distribution connection pipes 440, first and second return connection pipes 460 and 480, a bypass inlet pipe 510, a bypass discharge pipe 520, and collection connection pipes 620.

The inlet pipe 420 may be a pipe through which the cooling water is introduced into the base plate 400 (refer to FIG. 2). The inlet pipe 420 may deliver the cooling water introduced from outside the cooling module 410 to the supply manifold block 430.

The supply manifold block 430 may be connected to the inlet pipe 420 and may extend in the second direction to distribute the cooling water introduced from the inlet pipe 420 to the plurality of first channels 450. The supply manifold block 430 may distribute the cooling water to the first channels 450 through the distribution connection pipes 440.

The distribution connection pipes 440 may connect the supply manifold block 430 and the first channels 450.

The plurality of first channels 450 may be spaced apart from each other in the second direction and may be connected to the supply manifold block 430. The first channels 450 may include a portion extending in the first direction. The first channels 450 may be passages for receiving the cooling water from the supply manifold block 430 and causing the cooling water to flow to the return manifold block 470.

The cooling water may lower the temperature of the battery cell stacks 200 while flowing through the first channels 450. Accordingly, the closer to the inlet pipe 420, the lower the temperature of the cooling water, and the closer to the return manifold block 470, the higher the temperature of the cooling water.

The plurality of first channels 450 may include a pair of first-first channels 451 and a pair of first-second channels 452. The cooling water flowing through the first-first channels 451 and the cooling water flowing through the first-second channels 452 may not be mixed with each other.

To achieve this, the first-first channels 451 and the first-second channels 452 may be spaced apart from each other in the second direction. The pair of first-first channels 451 may be disposed inwardly of the pair of first-second channels 452 in the second direction. The pair of first-second channels 452 may be disposed outward of the pair of first-first channels 451 in the second direction.

Meanwhile, the first-first channels 451 and the first-second channels 452 may all be connected to the supply manifold block 430 by the distribution connection pipes 440. As illustrated in FIG. 6, each of the distribution connection pipes 440 may include first distribution connection pipes 441 connecting the supply manifold block 430 and the first-first channel 451 and second distribution connection pipes 442 connecting the supply manifold block 430 and the first-second channel 452.

Since the first-first channels 451 are closer to the inlet pipe 420 than the first-second channels 452, the pressure of the cooling water introduced into the first-first channels 451 may be higher than the pressure of the cooling water introduced into the first-second channels 452 when the number of first distribution connection pipes 441 is equal to the number of second distribution connection pipes 442. That is, the flow rate of the cooling water introduced toward the first-first channels 451 may be greater than the flow rate of the cooling water introduced toward the first-second channels 452.

In the instant case, the battery cell stacks 200 mounted on the middle area of the pack housing 300 in the second direction may be supercooled. To prevent this, the flow rate of the cooling water distributed from the supply manifold block 430 to the first-second channels 452 may be greater than the flow rate of the cooling water distributed from the supply manifold block 430 to the first-first channels 451.

That is, the number of second distribution connection pipes 442 may be greater than the number of first distribution connection pipes 441. For example, the number of second distribution connection pipes 442 connecting the supply manifold block 430 and each of the first-second channels 452 may be three, and the number of first distribution connection pipes 441 connecting the supply manifold block 430 and each of the first-first channels 451 may be two. However, the present disclosure is not limited thereto, and it is sufficient if the number of second distribution connection pipes 442 is greater than the number of first distribution connection pipes 441.

Alternatively, the number of second distribution connection pipes 442 and the number of first distribution connection pipes 441 may be equal to each other, and the cross-sectional area of the second distribution connection pipes 442 may be greater than the cross-sectional area of the first distribution connection pipes 441.

Meanwhile, as illustrated in FIG. 5, the first-first channel 451 may include a first area 451a, a first connection area 451b, a second area 451c, a second connection area 451d, and a third area 451e.

The first area 451a of the first-first channel 451 may be a portion which is connected to the supply manifold block 430 and that extends to the opposite side in the first direction (extends in the direction opposite to the X direction). The second area 451c of the first-first channel 451 may be a portion which is located downstream of the first area 451a of the first-first channel 451 with respect to the flow direction of the cooling water and that extends to the one side in the first direction (extends in the X direction). The third area 451e of the first-first channel 451 may be a portion which is located downstream of the second area 451c of the first-first channel 451 and that extends to the opposite side in the first direction (extends in the direction opposite to the X direction). The third area 451e of the first-first channel 451 may be connected to the return manifold block 470.

The first connection area 451b of the first-first channel 451 may be a portion that connects the first area 451a of the first-first channel 451 and the second area 451c of the first-first channel 451 and extends inward in the second direction.

The second connection area 451d of the first-first channel 451 may be a portion that connects the second area 451c of the first-first channel 451 and the third area 451e of the first-first channel 451 and extends inward in the second direction.

Likewise to the first-first channel 451, the first-second channel 452 may include a first area 452a, a first connection area 452b, a second area 452c, a second connection area 452d, and a third area 452e.

The first area 452a of the first-second channel 452 may be a portion which is connected to the supply manifold block 430 and that extends to the opposite side in the first direction (extends in the direction opposite to the X direction). The second area 452c of the first-second channel 452 may be a portion which is located downstream of the first area 452a of the first-second channel 452 with respect to the flow direction of the cooling water and that extends to the one side in the first direction (extends in the X direction). The third area 452e of the first-second channel 452 may be a portion which is located downstream of the second area 452c of the first-second channel 452 and that extends to the opposite side in the first direction (extends in the direction opposite to the X direction). The third area 452e of the first-second channel 452 may be connected to the return manifold block 470.

The first connection area 452b of the first-second channel 452 may be a portion that connects the first area 452a of the first-second channel 452 and the second area 452c of the first-second channel 452 and extends outward in the second direction.

The second connection area 452d of the first-second channel 452 may be a portion that connects the second area 452c of the first-second channel 452 and the third area 452e of the first-second channel 452 and extends outward in the second direction.

As described above, the plurality of first channels 450 may be formed in a meandering shape. The reason why the first channels 450 are formed in the meandering shape is for increasing the flow time of the cooling water flowing through the first channels 450 and the area of the first channels 450 by making the passage of the first channels 450 long. Accordingly, as the cooling water flows through the first channels 450, the battery cell stacks 200 (refer to FIG. 1) disposed on one side of the first channels 450 in the third direction (in the Z direction) may be cooled for a relatively long time period.

Meanwhile, as illustrated in FIG. 6, the first distribution connection pipes 441 and the second distribution connection pipes 442 may be connected to positions offset from the center portion of the first area 451a of the first-first channel 451 and the center portion of the first area 452a of the first-second channel 452 in the second direction (the Y direction or the direction opposite to the Y direction).

This may be for an area where the speed of the cooling water introduced into the first areas 451a and 452a of the first-first and first-second channels 451 and 452 is instantaneously zero, because the temperature of the cooling water flowing through the first areas 451a and 452a of the first-first and first-second channels 451 and 452 is lower than the temperature of the cooling water flowing through the other areas of the first-first and first-second channels 451 and 452.

In other words, since the first distribution connection pipes 441 and the second distribution connection pipes 442 are connected to the positions offset from the center portion of the first area 451a of the first-first channel 451 and the center portion of the first area 452a of the first-second channel 452 in the second direction (the Y direction or the direction opposite to the Y direction), the flow speed of the cooling water located in the portions that are not connected to the first distribution connection pipes 441 and the second distribution connection pipes 442 among the first areas 451a and 452a of the first-first and first-second channels 451 and 452 may be delayed or locally zero.

This structure may prevent supercooling of the battery cell stacks 200 cooled by the first areas 451a and 452a of the first-first and first-second channels 451 and 452 among the battery cell stacks 200 mounted in the pack housing 300.

In more detail, the first distribution connection pipes 441 may be connected, at a position inwardly of the center portion of the first area 451a of the first-first channel 451 in the second direction, to the first-first channel 451. The second distribution connection pipes 442 may be connected, at a position outward of the center portion of the first area 452a of the first-second channel 452 in the second direction, to the first-second channel 452.

The first distribution connection pipes 441 and the second distribution connection pipes 442 may be spaced apart from each other as far as possible in the second direction. This is to increase the flow rate of the cooling water flowing through a portion of the first area 451a of the first-first channel 451 and a portion of the first area 452a of the first-second channel 452 away from each other to be greater than the flow rate of the cooling water flowing through a portion of the first area 451a of the first-first channel 451 and a portion of the first area 452a of the first-second channel 452 adjacent to each other.

Due to the provided configuration, supercooling of the battery cell stack 200 disposed adjacent to the inlet pipe 420 among the battery cell stacks 200 mounted in the pack housing 300 may be prevented.

Referring again to FIGS. 4 and 5, the return manifold block 470 may be connected to the plurality of first channels 450 and may change the flow direction of the cooling water delivered from the plurality of first channels 450.

The return manifold block 470 may receive the cooling water from the first channels 450 and may return the cooling water to the plurality of second channels 490. The return manifold block 470 needs to extend in the second direction because the return manifold block 470 has to be connected to both the first channels 450 and the second channels 490.

The second channels 490 may connect the return manifold block 470 and the collection manifold block 600. The second channels 490 may be components that are disposed outward of the first channels 450 in the second direction and that cause the cooling water supplied from the return manifold block 470 to flow to the collection manifold block 600.

The reason why the second channels 490 are disposed outward of the first channels 450 in the second direction is for decreasing a difference in temperature between the first channels 450 and the second channels 490 in the second direction.

Since the cooling water flowing through the first channels 450 is cooling water just introduced into the cooling module 410 through the inlet pipe 420, the temperature of the cooling water flowing through the first channels 450 may be lower than the temperature of the cooling water flowing through the second channels 490.

Meanwhile, the cooling water flowing through the second channels 490 disposed outward of the first channels 450 in the second direction may be more affected by outside air than the cooling water flowing through the first channels 450.

Accordingly, even though the cooling water flowing through the second channels 490 has a higher temperature than the cooling water flowing through the first channels 450, the cooling water flowing through the second channels 490 may exchange heat with the outside air, and thus a temperature difference depending on the positions of the battery cell stacks 200 in the second direction may be reduced when compared to that in the structure in which the first channels are disposed outward of the second channels in the second direction.

The second channels 490 may be provided in pairs, and each of the second channels 490 may be implemented with three parallel channels. The second channels 490 may all extend toward the one side in the first direction (in the X direction) from the return manifold block 470 to the collection manifold block 600.

The collection manifold block 600 may collect the cooling water of the cooling module 410. The collection manifold block 600 may be connected to the discharge pipe 630 from which the cooling water is discharged and may deliver the collected cooling water to the discharge pipe 630.

The collection manifold block 600 may be connected to the second channels 490 through the collection connection pipes 620. Guide manifold blocks 610 may be provided between the collection manifold block 600 and the second channels 490.

The guide manifold blocks 610 is configured as buffers to enable smooth collection of the cooling water into the collection manifold block 600.

The cooling water recovered through the second channels 490 may not be directly collected into the collection manifold block 600, but may be buffered in the guide manifold blocks 610 and may be collected into the collection manifold block 600 with the flow speed reduced.

The collection manifold block 600 may be formed to be longer than the supply manifold block 430. The collection manifold block 600 may be connected, at positions outward of the supply manifold block 430 in the second direction, to the second channels 490.

Meanwhile, the cooling module 410 may not sufficiently reduce a temperature difference depending on the positions of the battery cell stacks 200 in the second direction with only the first channels 450 and the second channels 490. This is because, as described above, the battery cell stacks 200 disposed on the middle area of the pack housing 300 among the battery cell stacks 200 are less affected by the outside air.

Since the performance of the battery cells deteriorates when there is a temperature difference between the battery cell stacks 200 in the second direction, the cooling module 410 according to an exemplary embodiment of the present disclosure may further include the bypass channel 500 that bypasses the first channels 450, receives the cooling water from the supply manifold block 430, and delivers the cooling water to the return manifold block 470 through a passage shorter than the first channels 450.

The bypass channel 500 may be disposed between the plurality of first channels 450 in the second direction to cool areas of the battery cell stacks 200 located inside in the second direction.

The bypass channel 500 may be spaced apart from the plurality of first channels 450 in the second direction. The bypass channel 500 may be disposed between the pair of first-first channels 451 to be spaced apart from the first-first channels 451. The cooling water flowing through the bypass channel 500 may not be mixed with the cooling water flowing through the first-first and first-second channels 451 and 452.

Since the bypass channel 500 is implemented as a passage shorter than the first channels 450, the temperature of the cooling water flowing through the bypass channel 500 may be lower than the temperature of the cooling water flowing through the first channels 450.

Unlike the first channels 450, the bypass channel 500 may extend only toward the opposite side in the first direction (may extend only in the direction opposite to the X direction) from the supply manifold block 430 to the return manifold block 470.

The bypass channel 500 may be connected to the supply manifold block 430 through the bypass inlet pipe 510 and may be connected to the return manifold block 470 through the bypass discharge pipe 520.

The supply manifold block 430 and the return manifold block 470 may be connected, at a position inwardly of the first channels 450 in the second direction, to the bypass channel 500. The return manifold block 470 and the collection manifold block 600 may be connected, at a position inwardly of the second channels 490 in the second direction, to the first channels 450.

The supply manifold block 430 and the return manifold block 470 may be connected, at a position outward of the bypass channel 50 in the second direction, to the first channels 450. The return manifold block 470 and the collection manifold block 600 may be connected, at a position outward of the first channels 450 in the second direction, to the second channels 490.

In other words, the distribution connection pipes 440 may be disposed outward of the bypass inlet pipe 510 in the second direction, and the collection connection pipes 620 may be disposed outward of the distribution connection pipes 440 in the second direction.

Furthermore, the first return connection pipes 460 may be disposed outward of the bypass discharge pipe 520 in the second direction, and the second return connection pipes 480 may be disposed outward of the first return connection pipes 460 in the second direction.

Meanwhile, the first channels 450, the second channels 490, and the bypass channel 500 may all be formed of an extruded material, and thus the rigidity thereof may be reinforced when compared to that of a structure manufactured by a press forming process.

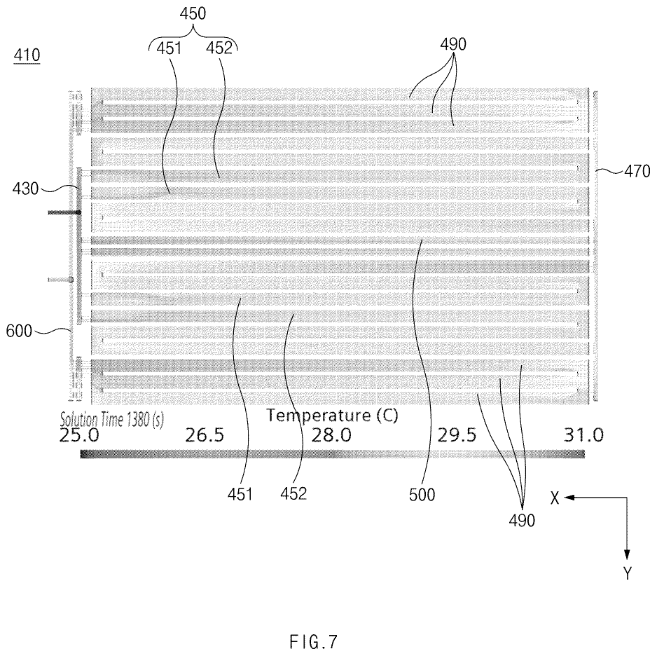

FIG. 7 is a view exemplarily illustrating the temperature of cooling water flowing through the cooling module according to an exemplary embodiment of the present disclosure.

Referring to FIG. 7, it may be confirmed that the cooling water flows from the supply manifold block 430 to the return manifold block 470 through one of the first-first channels 451, the first-second channels 452, and the bypass channel 500.

Thereafter, the cooling water introduced into the return manifold block 470 may be collected into the collection manifold block 600 through the second channels 490.

Since the cooling water flowing upstream with respect to the flow direction of the cooling water is cooling water just introduced into the cooling module 410, the temperature of the cooling water may be relatively low, and since the cooling water flowing downstream with respect to the flow direction of the cooling water is cooling water that cools the battery cell stacks 200 (refer to FIG. 1), the temperature of the cooling water may be relatively high.

For example, in the first-first and first-second channels 451 and 452, the cooling water flowing through the area close to the supply manifold block 430 with respect to the flow direction of the cooling water may have a relatively low temperature, and the cooling water flowing through the area close to the return manifold block 470 may have a relatively high temperature.

Meanwhile, the cooling water flowing through the bypass channel 500 may be introduced into the return manifold block 470 in a lower temperature state than the cooling water flowing through the first-first and first-second channels 451 and 452.

The cooling water introduced into the return manifold block 470 through the bypass channel 500 may flow into the second channels 490. In the second channels 490, the cooling water flowing through the bypass channel 500 may be mixed with the cooling water introduced into the second channels 490 through the first channels 450.

Accordingly, the temperature of the cooling water flowing through the second channels 490 according to an exemplary embodiment of the present disclosure may be lower than the temperature of cooling water flowing through second channels of a cooling module without a bypass channel structure.

Due to the provided configuration, a temperature difference of the cooling module 410 in the second direction may be reduced, and a temperature difference between the battery cell stacks 200 depending on positions in the second direction may be reduced. Thus, a difference in performance between the battery cells may be prevented.

As described above, the cooling water flowing through the bypass channel that bypasses the first channels may be introduced into the second channels, and thus the difference in temperature between the battery cells in the width direction may be reduced.

The cooling water may flow through the bypass channel that bypasses the first channels, and thus the cooling of the battery cells located on the middle area in the width direction may be improved.

The flow rate of the cooling water introduced into each of the first-first and first-second channels may be adjusted, and thus the temperature difference between the battery cells in the width direction may be reduced.

The first and second distribution connection pipes may be connected to the positions offset from the centers of the first-first and first-second channels in the width direction, and thus the battery cells cooled by the cooling water flowing through the first-first and first-second channels may be prevented from being supercooled.

The flow direction of the cooling water flowing through the first channels may be changed, and thus the contact time of the battery cells and the cooling water flowing through the first channels may be increased so that the cooling performance of the battery cells may be improved.

The base plate of the cooling module may be manufactured using an extrusion mold, and thus the productivity and rigidity may be improved.

Furthermore, the present disclosure may provide various effects that are directly or indirectly recognized.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed based on the accompanying claims, and all the technical ideas within the scope equivalent to the claims should be included in the scope of the present disclosure.

What is claimed is:

1. A cooling module comprising:
a supply manifold block connected to an inlet pipe into which cooling water is introduced, and distributing the cooling water;
a collection manifold block connected to a discharge pipe from which the cooling water is discharged, collecting and delivering the cooling water to the discharge pipe;
a plurality of first channels including a portion connected to the supply manifold block and extending in one direction, the plurality of first channels being spaced apart from each other;
a return manifold block connected to the plurality of first channels and changing a flow direction of the cooling water delivered from the plurality of first channels;
a plurality of second channels connecting the return manifold block and the collection manifold block; and
a bypass channel bypassing the plurality of first channels, receiving the cooling water from the supply manifold block, and delivering the cooling water to the return manifold block through a passage shorter than the plurality of first channels.

2. The cooling module of claim 1, wherein the bypass channel is disposed between the plurality of first channels in a direction crossing the one direction and extends in the one direction from the supply manifold block to the return manifold block.

3. The cooling module of claim 1, wherein the bypass channel is spaced apart from the plurality of first channels in a direction crossing the one direction.

4. The cooling module of claim 1, wherein each of the first channels includes:
a first area connected to the supply manifold block and extending in the one direction; and
a second area located downstream of the first area with respect to the flow direction of the cooling water and extending in an opposite direction opposite to the one direction.

5. The cooling module of claim 4, wherein the first channel further includes a third area located downstream of the second area with respect to the flow direction of the cooling water and extending in the one direction, the third area being connected to the return manifold block.

6. The cooling module of claim 5, wherein the first channel further includes:
a first connection area connecting the first area and the second area and extending in a direction crossing the one direction; and
a second connection area connecting the second area and the third area and extending in the direction crossing the one direction.

7. The cooling module of claim 1, wherein the plurality of first channels include:
a first-first channel; and
a first-second channel disposed outward of the first-first channel in a direction crossing the one direction and spaced apart from the first-first channel, and
wherein a flow rate of the cooling water distributed from the supply manifold block to the first-second channel is greater than a flow rate of the cooling water distributed from the supply manifold block to the first-first channel.

8. The cooling module of claim 7, further comprising:
at least one first distribution connection pipe connecting the supply manifold block and the first-first channel; and
at least one second distribution connection pipe connecting the supply manifold block and the first-second channel,
wherein a number of the at least one second distribution connection pipe is greater than a number of the at least one first distribution connection pipe.

9. The cooling module of claim 7, further comprising:
a first distribution connection pipe connecting the supply manifold block and the first-first channel; and
a second distribution connection pipe connecting the supply manifold block and the first-second channel,
wherein a cross-sectional area of the second distribution connection pipe is larger than a cross-sectional area of the first distribution connection pipe.

10. The cooling module of claim 7,
wherein each of the first-first channel and the first-second channel includes a first area connected to the supply manifold block and extending in the one direction,
wherein the cooling module further comprises:
a first distribution connection pipe connecting the supply manifold block and the first-first channel; and
a second distribution connection pipe connecting the supply manifold block and the first-second channel, and
wherein the first distribution connection pipe and the second distribution connection pipe are connected to positions offset from a center portion of the first area of the first-first channel and a center portion of the first area of the first-second channel in the direction crossing the one direction.

11. The cooling module of claim 10,
wherein the first distribution connection pipe is connected, at a position inwardly of the center portion of the first area of the first-first channel in the direction crossing the one direction, to the first-first channel, and
wherein the second distribution connection pipe is connected, at a position outward of the center portion of the first area of the first-second channel in the direction crossing the one direction, to the first-second channel.

12. The cooling module of claim 7, wherein the supply manifold block is connected, at a position inwardly of the plurality of first channels in the direction crossing the one direction, to the bypass channel.

13. The cooling module of claim 1, wherein the return manifold block is connected, at a position inwardly of the plurality of first channels in a direction crossing the one direction, to the bypass channel.

14. The cooling module of claim 1, wherein each of the second channels is disposed outward of the plurality of first channels in a direction crossing the one direction.

15. The cooling module of claim 1, wherein the return manifold block is connected, at a position outward of the plurality of first channels in a direction crossing the one direction, to the plurality of second channels.

16. The cooling module of claim 1, wherein the plurality of first channels, the plurality of second channels, and the bypass channel are formed of an extruded material.

17. A battery pack comprising:
a battery cell stack including battery cells stacked in one direction and extending in a direction crossing the one direction; and
a base plate supporting the battery cell stack, the base plate including a cooling module therein,
wherein the cooling module includes:
a supply manifold block connected to an inlet pipe into which cooling water is introduced, and distributing the cooling water;
a collection manifold block connected to a discharge pipe from which the cooling water is discharged, collecting and delivering the cooling water to the discharge pipe;
a plurality of first channels including a portion connected to the supply manifold block and extending in the one direction, the plurality of first channels being spaced apart from each other;
a return manifold block connected to the plurality of first channels and changing a flow direction of the cooling water delivered from the plurality of first channels;
a plurality of second channels connecting the return manifold block and the collection manifold block; and
a bypass channel bypassing the plurality of first channels, receiving the cooling water from the supply manifold block, and delivering the cooling water to the return manifold block through a passage shorter than the plurality of first channels.

18. The battery pack of claim 17, wherein the bypass channel is disposed between the plurality of first channels in a direction crossing the one direction and extends in the one direction from the supply manifold block to the return manifold block.

19. The battery pack of claim 17, wherein the bypass channel is spaced apart from the plurality of first channels in a direction crossing the one direction.
